(19) United States
(12) Patent Application Publication
(10) Pub. No.: US 2012/0002826 A1
(43) Pub. Date: Jan. 5, 2012

(54) ELECTRET ELECTROACOUSTIC TRANSDUCER

(75) Inventors: Tsung-Hung WU, Hsinchu (TW); Zhi-Yuan LIOU, Tainan (TW)

(73) Assignee: Tsung-Hung WU, Hsinchu (TW)

(21) Appl. No.: 12/859,296

(22) Filed: Aug. 19, 2010

(30) Foreign Application Priority Data
Jun. 30, 2010 (TW) 99212462

(51) Int. Cl. H04R 25/00

(52) U.S. Cl. 381/191

(57) ABSTRACT

An electret electroacoustic transducer comprises first porous complex electrode, support member, electret vibrating film and first adjustment member. Support member is configured on the first porous complex electrode. The fixed portion of the electret vibrating film is fixed on the support member. Adjustment member is set between the first porous complex electrode and the electret vibrating film. A sectional difference is formed between the fixed portion and the adjusted portion of the electret vibrating film.

### RELATED APPLICATIONS

This application claims priority to Taiwan Application Serial Number 99212462, filed Jun. 30, 2010, which is herein incorporated by reference.

### BACKGROUND

1. Field of Invention

The present invention relates to an electroacoustic transducer. More particularly, the present invention relates to an electret electroacoustic transducer.

2. Description of Related Art

Please refer to FIG. 1. FIG. 1 is a schematic diagram of a sectional view of a conventional electret electroacoustic transducer. The conventional electret electroacoustic transducer 100 which is an acoustical device based on the Coulomb's Law. The Coulomb's Law is a law describing two objects induced push-pull effect when two objects have same or opposite electric properties at the same time. The diaphragm 112 composed of electret material is disposed between the electrodes 114a, 114b. The alternating signal source 116 is connected to the electrodes 114a, 114b. Therefore, the alternating voltage induces an alternating electrostatic force between the electrodes 114a, 114b and the charged diaphragm 112. Then, the diaphragm 112 vibrates and generates sound waves.

According to the Coulomb's Law, the magnitude of the electrostatic force between two point electric charges is directly proportional to the product of the magnitudes of each of the charges and inversely proportional to the square of the distance between the two charges. Therefore, the transduction efficiency, the sensitivity of the transducer, is depended on the static electricity charges on the diaphragm 112 and the gap between the diaphragm 112 and the electrodes 114a, 114b. However, due to the material property and the electrical stability, it is difficult to increase the static electricity charges on the diaphragm 112 too much. Hence, the conventional method to increase transduction efficiency is reducing the gap between the diaphragm 112 and the electrodes 114a, 114b.

Meanwhile side effects arise that the diaphragm 112 is easier to touch the electrodes 114a, 114b when the gap is reduced. Such touch can cause the distortion of sound and reduces the lifetime of the electret electroacoustic transducer 100.

Moreover, the outer static electricity and humidity also affect the charges of the diaphragm and reduce the lifetime and stability of the electret electroacoustic transducer.

Furthermore, due to the small volume uniqueness of the electret electroacoustic transducer, the electret electroacoustic transducer is usually expected to be disposed in the small electronic product. However, the confinement space of the electronic device is bad ventilation and reduces the efficiency of the electret electroacoustic transducer as well.

Therefore, low to improve the electret electroacoustic transducer to overcome the deficiencies described above, and then to increase the lifetime and the electroacoustic transduction efficiency of the electret electroacoustic transducer are the important subjects.

### SUMMARY

In accordance with the foregoing and other objectives of the present invention, an electret electroacoustic transducer is provided.

The electret electroacoustic transducer comprises a first porous complex electrode, a support member, an electret vibrating film, and a first adjustment member. The support member is disposed on the first porous complex electrode. The electret vibrating film has a fixed portion fixed on the support member. The first adjustment member is disposed between the first porous complex electrode and the electret vibrating film. The electret vibrating film has an adjusted portion contiguous with the first adjustment member. A sectional difference is formed between the fixed portion and the adjusted portion.

In accordance with another embodiment of the present invention, an electret electroacoustic transducer is provided. The electret electroacoustic transducer comprises a pair of porous complex electrodes, a support member, a through hole, an electret vibrating film, a first adjustment member, and a film. The support member is disposed between the pair of porous complex electrodes. The through hole is disposed on the support member and penetrates the electret electroacoustic transducer. The electret vibrating film is disposed between the pair of porous complex electrodes. The electret vibrating film has a fixed portion which is fixed on the support member. The first adjustment member is disposed in a space between one of the porous complex electrodes and the electret vibrating film. The electret vibrating film has an adjusted portion contiguous with the first adjustment member. A sectional difference is formed between the fixed portion and the adjusted portion. The film is disposed in one side of the porous complex electrode opposite to the electret vibrating film.

The embodiment has the adjustment member disposed between the electret vibrating film and the porous complex electrode, so that, a sectional difference is formed between the fixed portion and the adjusted portion of the electret vibrating film. Therefore, it prevents instability of the interaction between the vibrating film and the electrode. Moreover, the adjustment member could control the dynamic characteristic of the vibrating film, adjust the direction of sound and reduce the gap between the electrode and some portion of the vibrating film to increase the transduction efficiency.

The porous complex electrode further comprises an inner electrostatic protection layer and an outer electrostatic protection layer. The inner electrostatic protection layer is closer to the electret vibrating film than the outer electrostatic protection layer. The inner electrostatic protection layer comprises Polyvinyl Alcohol (PVA) material.

The inner electrostatic protection layer could prevent the touch between the vibrating film and the electrode from affecting the electrostatic charge of the vibrating film. The outer electrostatic protection layer could prevent the outer static electricity from affecting the property of the vibrating film. The film could isolate the outer static electricity and the outer humidity. The through hole could improve the ventilation to increase the electroacoustic transduction efficiency of the transducer when the transducer is disposed in a confinement space of the electronic device.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a sectional view of a conventional electret electroacoustic transducer.

FIG. 2A is a schematic diagram of a top view of the electret electroacoustic transducer of the embodiment of the present invention.

FIG. 2B is a schematic diagram of a sectional view along line AB shown in FIG. 2A.

FIG. 2C is a schematic diagram of a sectional view of an electret electroacoustic transducer of one embodiment of the present invention.

FIG. 3A and FIG. 3B are schematic diagrams of a sectional view of an electret electroacoustic transducer of embodiments of the present invention.

FIG. 4 is a schematic diagram of a sectional view of other embodiment of the present invention.

FIG. 5 is a schematic diagram of a sectional view of the porous complex electrode of one embodiment of the present invention.

FIG. 6 is a schematic diagram of a speaker module composed of the electret electroacoustic transducers.

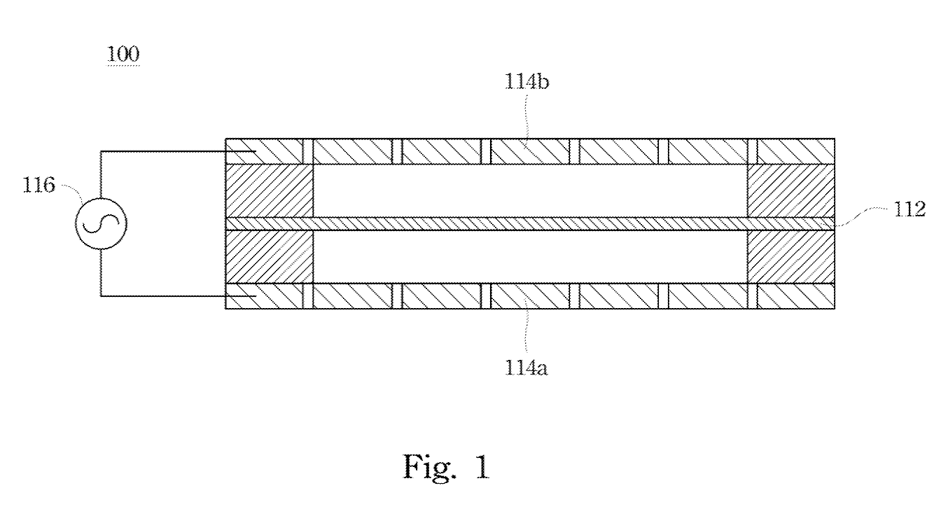

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The all embodiments of the present invention could change the size of the adjustment members to adjust the structure between the electret vibrating film, porous complex electrode, and the support member. Therefore, the vibrating property of the vibrating film and the direction of sound could be controlled. The electret vibrating film could be made from fluorine series polymer, such as Fluorinated Ethylene Propylene Copolymer (FEP), Polytetrafluoroethene (PTFE), and Polyvinylidene fluoride (PVDF). Moreover, the electret vibrating film also could be made from other suitable material.

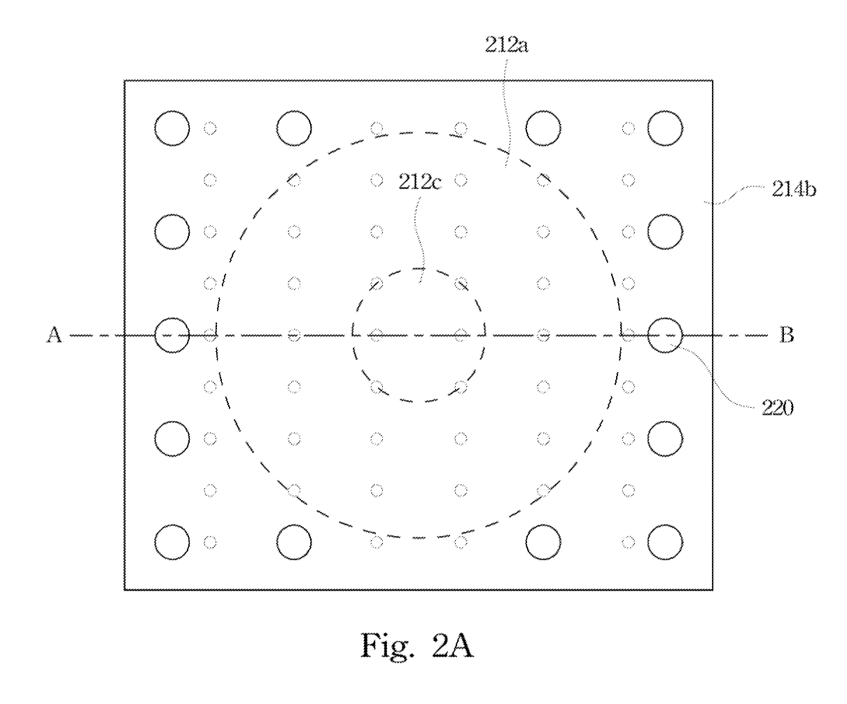

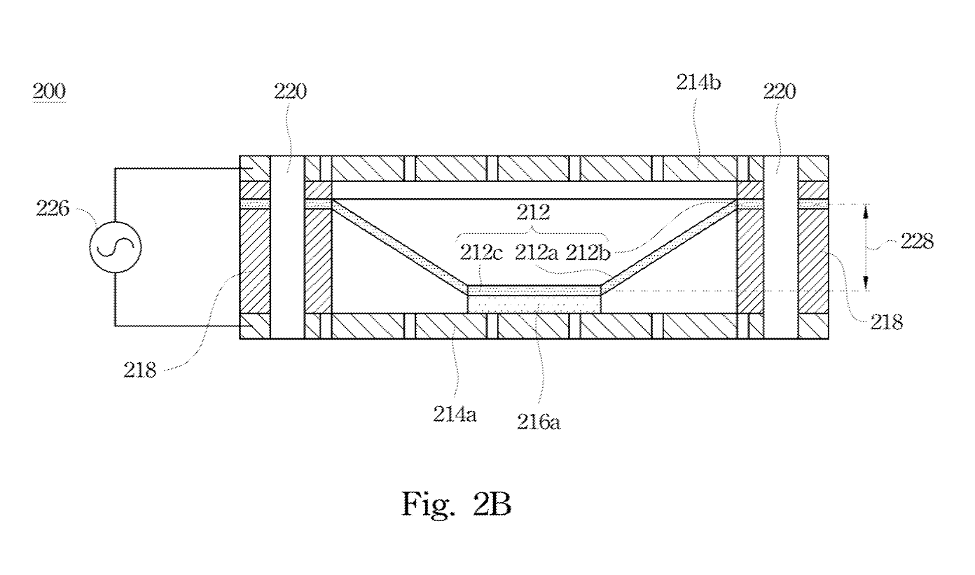

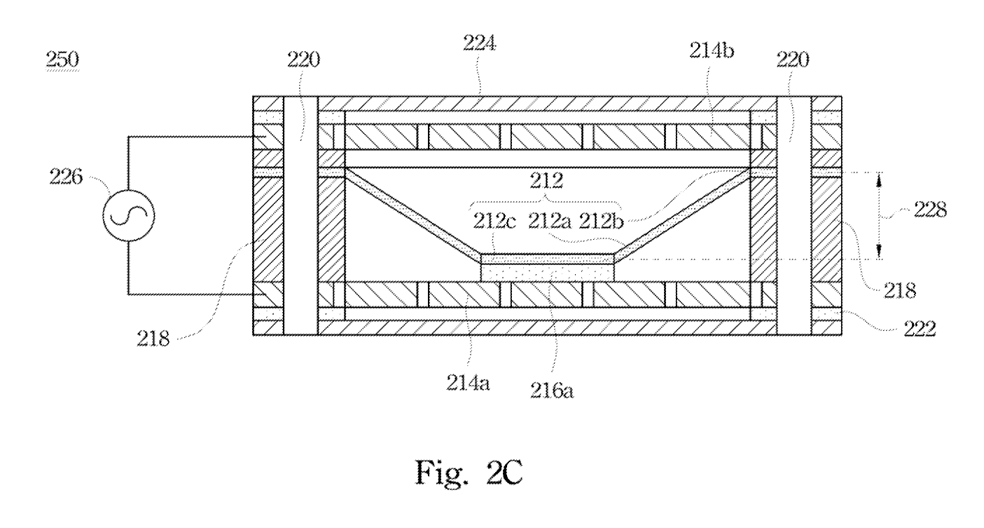

Please refer to FIG. 2A and FIG. 2B together. FIG. 2A is a schematic diagram of a top view of the electret electroacoustic transducer. FIG. 2B is a schematic diagram of a sectional view along line AB shown in FIG. 2A. The electret electroacoustic transducer 200 comprises a first porous complex electrode 214a, a support member 218, an electret vibrating film 212, and a first adjustment member 216a. The support member 218 is disposed on the first porous complex electrode 214a. The electret vibrating film 212 has a fixed portion 212b fixed on the support member 218.

The first adjustment member 216a is disposed between the first porous complex electrode 214a and the electret vibrating film 212. The electret vibrating film 212 has an adjusted portion 212c contiguous with the first adjustment member 216a. Therefore, a sectional difference 228 is formed between the fixed portion 212b and the adjusted portion 212c.

Due to the disposition of the first adjustment member 216a, the electret vibrating film 212 could be separated as three parts, i.e. the vibrating portion 212a induced vibration, the fixed portion 212b fixed on the support member 218, and the adjusted portion 212c fixed on the adjusted member 216a.

The first adjustment member 216a is disposed between the first porous complex electrode 214a and the electret vibrating film 212. Therefore, the sectional 228 is formed between the fixed portion 212b and the adjusted portion 212c of the electret vibrating film 212. In other words, because of the disposition of the first adjustment member 216a, the vibrating portion 212a of the electrets vibrating film 212 is non-parallel with the first porous complex electrode 214a.

In this embodiment, the first adjustment member 216a is adhesive material or a viscose, such as twin adhesive. The adjustment member 216a adheres the adjusted portion 212c to the first porous complex electrode 214a. Moreover, the adjustment member 216a could be formed by adhesive dispensing in the manufacturing process of the electret electroacoustic transducer 200.

Because the disposition of the first adjustment member 216a, the vibrating portion 212a of the electrets vibrating film 212 is non-parallel with the first porous complex electrode 214a. The non-parallel structure could adjust the direction of the sound.

Moreover, the electret electroacoustic transducer 200 further comprises a second porous complex electrode 214b. The second porous complex electrode 214b is disposed on the support member 218 opposite to the first porous complex electrode 214a. So the electret vibrating film 212 is disposed between the first porous complex electrode 214a and the second porous complex electrode 214b. For example, when the electret vibrating film 212 is monocharged and the first porous complex electrode 214a and second porous complex electrode 214b are given different electrical source with each other alternately, the vibrating portion 212a vibrates and generates sound waves. Sound waves propagate through the holes of the porous complex electrode 214a, 214b.

In the embodiment, the support member 218 is a block having a hollow construction. The support member 218 and porous complex electrodes 214a, 214b form the vibrating space of the electret vibrating film 212. In other embodiments, the support member could compose of a plurality of blocks. The structure of the support member described herein is not a restriction.

Moreover, the electret electroacoustic transducer 200 further comprises at least one through holes 220. The through holes 220 are disposed on the support member 218. The through holes 220 penetrate the electret electroacoustic transducer 200. In other words, the through holes 220 penetrate the support member 218, the corresponded portion of the porous complex electrodes and the electret vibrating film. Due to the small volume uniqueness of the electret electroacoustic transducer 200, the electret electroacoustic transducer 200 is usually expected to be disposed in the small electronic product. However, the confinement space of the electronic device is bad ventilation and reduces the efficiency of the electret electroacoustic transducer 200 as well. The disposition of the through holes improves the ventilation, reduces the obstruction of hitting air, and increases the electroacoustic transduction efficiency of the electret electroacoustic transducer 200. The number and size of the through hole are depended on the application. If the electret electroacoustic transducer needs the well ventilation, the number and size of the through hole are increased based on the allowed structural strength of the electret electroacoustic transducer.

Moreover, in other embodiment, the through hole also could penetrate the adjustment member and corresponded portion of the electret vibrating film. Furthermore, a hole could be disposed on the adjustment member. Therefore, when the vibrating film vibrates, the adjustment member could be a sound source unit to increase the electroacoustic transduction efficiency of the transducer.

Please refer to FIG. 2B and FIG. 2C together. FIG. 2C is a schematic diagram of a sectional view of an electret electroacoustic transducer of one embodiment of the present invention. In order to reduce the interference of the outer humidity and the outer static electricity, besides the elements of the embodiment described above, the electret electroacoustic transducer 250 of this embodiment further comprises a film covering the electret electroacoustic transducer 200 described above. In particularly, the film is disposed in one side of the porous complex electrode opposite to the electret vibrating film. In this embodiment, the film 224 is a film without void. The film 224 is fixed on the electret electroacoustic transducer 200 by the fixing member 222, and surrounds the electret electroacoustic transducer 200.

The fixing member 222 could be a twin adhesive, a viscose, or a screw to fix the film 224. Moreover, the fixing member 222 could adhere two films directly to cover the electroacoustic transducer 200 totally (not illustrated herein). The film 224 is a Polyvinyl Alcohol (PVA) film or an antistatic polyethylene (PE) film. Moreover, a conductive layer could be formed on the film 224 to achieve the function of the electrostatic protection. In addition, the film 224 could totally cover or partially cover the electroacoustic transducer 200 according to the application. Furthermore, the fixed method of the film 224 also could depend on the application.

In this embodiment, the through holes 220 also penetrate the film 224 to obtain the well ventilation. Moreover, the penetrated portion of the film 224 and the electroacoustic transducer 200 are airtight. However, when the electret electroacoustic transducer 200 is disposed in an open space or not disposed in confinement space, the through holes 220 could be removed to reduce the step of manufacturing and decrease the cost.

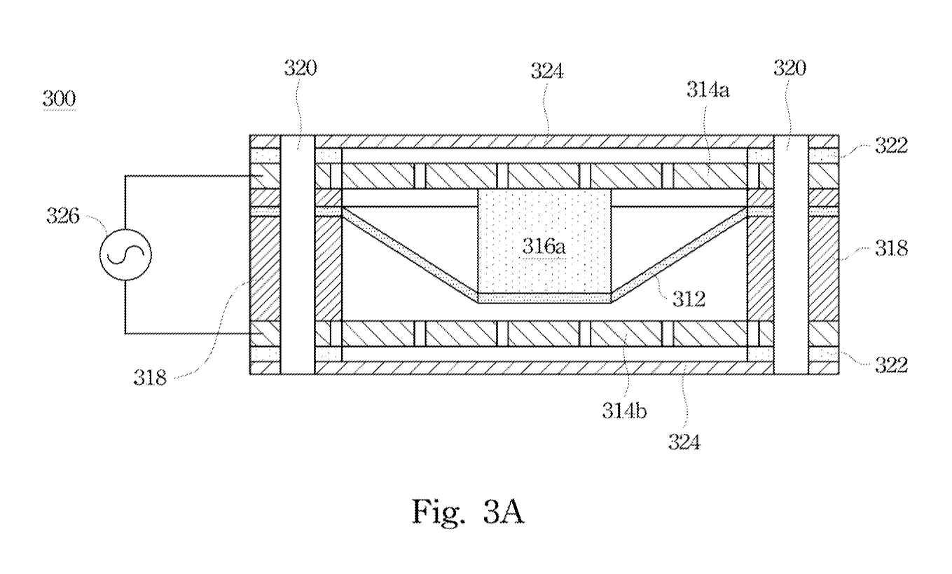

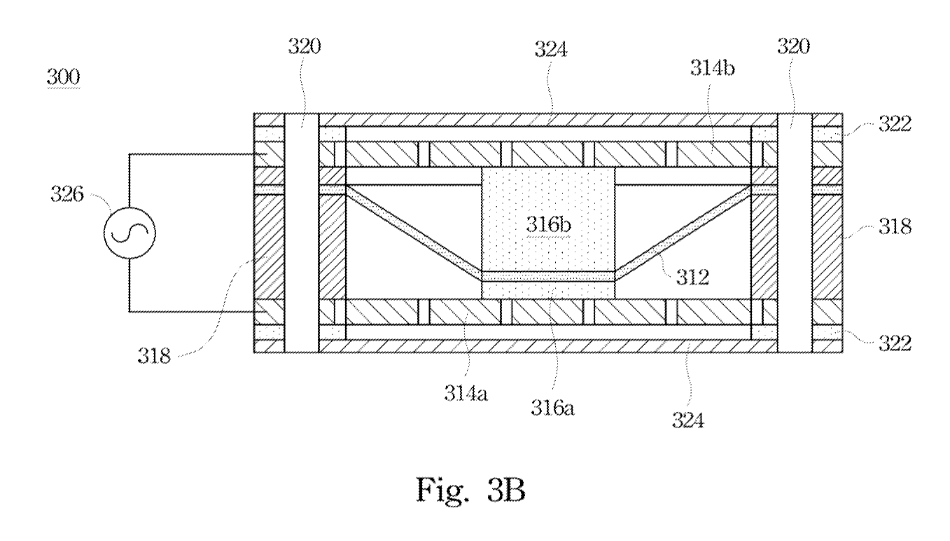

Please refer to FIG. 3A and FIG. 3B. FIG. 3A and FIG. 3B is a schematic diagram of a sectional view of other embodiments of the present invention. FIG. 3A and FIG. 3B is a diagram used for describing a variation of the disposition of the adjustment members. Therefore, the features as same as the embodiments described above are not described herein.

In FIG. 3A, the thickness of the first adjustment member 316a is increased. The position of the support member 318 which the electret vibrating film 312 is fixed on is changed. However, this embodiment also has the same advantages described above.

In FIG. 3B, this embodiment further comprises a second adjustment member 316b. The second adjustment member 316b is disposed between the second porous complex electrode 314b and the electret vibrating film 312. Due to the disposition of the first and second adjustment member 316a, 316b, the fixed strength of the electret vibrating film 312 is increased. Moreover, it also avoids the separation between the electret vibrating film 312 and the adjustment members 316a, 316b when the electret vibrating film 312 is vibrating.

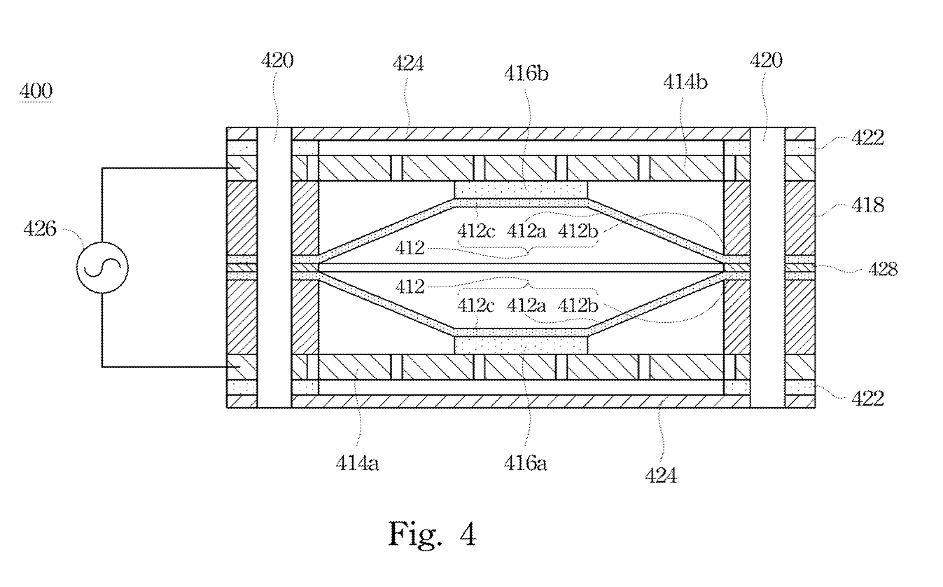

The electret vibrating film has a variety of patterns. An embodiment which comprises a separable double layers structure electret vibrating film is provided herein. Please refer to FIG. 4. FIG. 4 is a schematic diagram of a sectional view of other embodiment of the present invention. In this embodiment, the electret vibrating films 412 are a separable double layers structure. The electret vibrating films 412 are adhered at fixed portions 412b by adhesive material 428. The first and second adjustment members 416a, 416b are disposed in the space between the first porous complex electrode 414a and the electret vibrating film 412 and disposed in the space between the second porous complex electrode 414b and the electret vibrating film 412 separately. The sectional differences are formed between the fixed portions 412b and the adjusted portions 412c separately. In other words, the adjust portions 412c of the electret vibrating films 412 are near to two porous complex electrodes 414a, 414b separately. Moreover, in other embodiment, the adjust portions of the electret vibrating films can be disposed near to one of the porous complex electrodes when the electret vibrating films 412 are forced to be deformed toward the same porous complex electrode by adjusting the adjusting member properly.

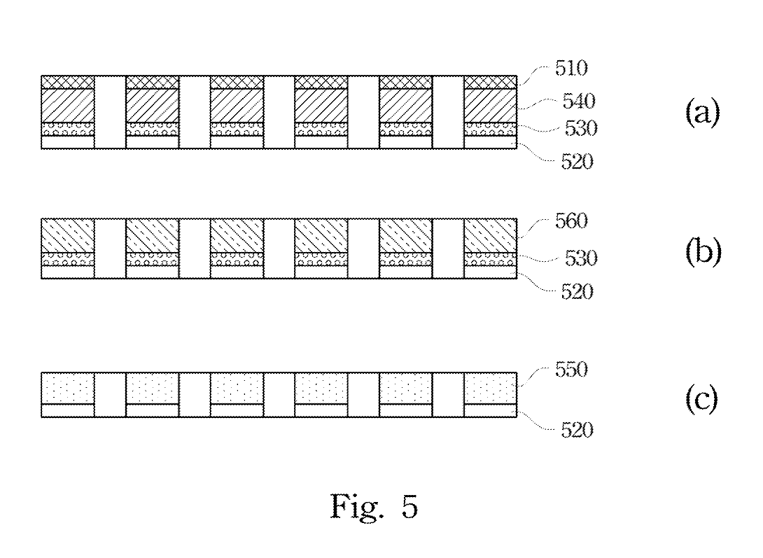

Please refer to FIG. 5. FIG. 5 is a schematic diagram of a sectional view of the porous complex electrode of one embodiment of the present invention. The porous complex electrode has a variety of patterns illustrated in FIGS. 5 (a), (b) and (c). In order to increase the electrostatic protection of the electret electroacoustic transducer, the porous complex electrode further comprises an inner electrostatic protection layer 520 and an outer electrostatic protection layer 510. The inner electrostatic protection layer 520 is closer to the electret vibrating film than the outer electrostatic protection layer 510. The inner electrostatic protection layer 520 comprises PVA material. PVA material is non-charged and hygroscopic. Therefore, the inner electrostatic protection layer 520 could avoid the discharge of the vibrating film when the vibrating film touches the electrode. Then inner electrostatic protection layer 520 also could block humidity coming from outside. Moreover, PVA is water solubility polymeric material. Therefore, the PVA could be formed on the inner electrostatic protection layer 520 by coating or immersion. It is low coat and easy to actualize.

The outer electrostatic protection layer is a conductor or antistatic material, such as metal electrode 550. In addition, the porous complex electrode further comprises a conductive layer 530 and a non-metal material layer 540. The non-metal material layer 540 is disposed between the conductive layer 530 and the outer electrostatic protection layer 510. The conductive layer 530 is contiguous with the inner electrostatic protection layer 520. In this situation, the outer electrostatic protection layer 510 could be a metal layer comprising holes or a metal coating layer. The metal layer such as metal wire gauze could increase the high frequency of sound. The metal coating layer could be an electrostatic protection layer. Furthermore, in FIG. 5 (b), the outer electrostatic protection layer is an antistatic non-metal material layer 560. In this situation, a conductive layer 530 is disposed between the antistatic non-metal material 560 layer and the inner electrostatic protection layer 520.

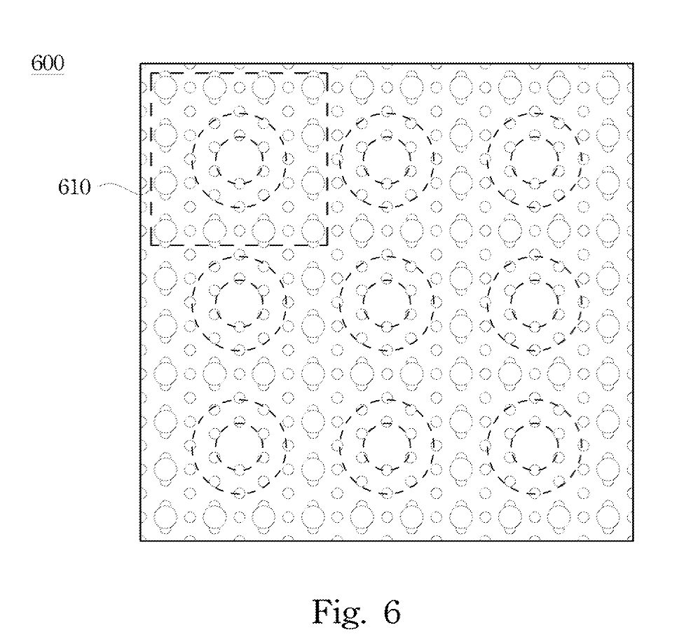

Please refer to FIG. 6. FIG. 6 is a schematic diagram of a speaker module composed of the electret electroacoustic transducers. In order to increase acoustic pressure of the sound, the speaker module could comprise a plurality of electret electroacoustic transducers shown in FIG. 6 in some application.

The embodiments described above dispose the adjustment member between the electret vibrating film and the porous complex electrode, so that a sectional difference is formed between the fixed portion and the adjusted portion of the electret vibrating film. The vibrating portion of the electrets vibrating film is non-parallel with the porous complex electrode. Therefore, it avoids unstable electrification of the vibrating film which is due to the charge of vibrating film attracted to the electrode. Moreover, the adjustment member could control the vibrating property of the vibrating film to adjust the direction of sound and reduce the gap between the electrode and some portion of the vibrating film to increase the transduction efficiency. It is important to note that the size, number, and shape of the adjustment member are depended on the design of the transducer. Moreover, the basic condition is that a sectional difference is formed between the fixed portion and the adjusted portion of the electret vibrating film.

In all embodiments, the adjustment member is adhesive material or a viscose. The adjustment member adheres the adjusted portion to the porous complex electrode. Moreover, the adjustment member could be formed by adhesive dispensing in the manufacturing process of the electret troacoustic transducer.

The porous complex electrode further comprises an inner electrostatic protection layer and an outer electrostatic protection layer. The inner electrostatic protection layer is closer to the electret vibrating film than the outer electrostatic protection layer. The inner electrostatic protection layer comprises PVA material.

The inner electrostatic protection layer could prevent the touch between the vibrating film and the electrode from affecting the electrostatic charge of the vibrating film. The outer electrostatic protection layer could prevent the outer static electricity from affecting the property of the vibrating film. The film could isolate the outer static electricity from the outer humidity. The through hole could improve the ventilation to increase the electroacoustic transduction efficiency of the transducer when the transducer is disposed in a confinement space of the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electret electroacoustic transducer comprising:
a first porous complex electrode;
a support member, disposed on the first porous complex electrode;
an electret vibrating film, the electret vibrating film having a fixed portion fixed on the support member;
a first adjustment member, disposed between the first porous complex electrode and the electret vibrating film, wherein the electret vibrating film has an adjusted portion contiguous with the first adjustment member, a sectional difference is formed between the fixed portion and the adjusted portion.

2. The transducer of claim 1, further comprising a second porous complex electrode, disposed on the support member opposite to the first porous complex electrode, wherein the electret vibrating film is disposed between the first porous complex electrode and the second porous complex electrode.

3. The transducer of claim 2, further comprising a second adjustment member, wherein the second adjustment member is disposed between the second porous complex electrode and the electret vibrating film.

4. The transducer of claim 3, wherein the electret vibrating film is a separable double layers structure, and the adjust portions of the electret vibrating films are disposed near to one of the porous complex electrode or the adjust portions of the electret vibrating films are near to two porous complex electrodes.

5. The transducer of claim wherein the adjustment members are adhesive material or viscose.

6. The transducer of claim 1, further comprising at least one through hole, disposed on the support member and penetrating the electret electroacoustic transducer.

7. The transducer of claim 1, further comprising a film disposed in one side of the porous complex electrode opposite to the electret vibrating film, wherein the film is a PVA film, an antistatic PE film or a film having a conductive layer.

8. The transducer of claim 1, wherein the porous complex electrode further comprises an inner electrostatic protection layer and an outer electrostatic protection layer, the inner electrostatic protection layer is closer to the electret vibrating film than the outer electrostatic protection layer.

9. The transducer of claim 8, wherein the inner electrostatic protection layer comprises PVA material.

10. The transducer of claim 9, wherein the outer electrostatic protection layer is a conductor or antistatic material.

11. The transducer of claim 9, wherein the porous complex electrode further comprises a conductive layer and a non-metal material layer, the non-metal material layer is disposed between the conductive layer and the outer electrostatic protection layer, the conductive layer is contiguous with the inner electrostatic protection layer.

12. An electret electroacoustic transducer comprising:
a pair of porous complex electrodes;
a support member, disposed between the pair of porous complex electrodes;
a through hole, disposed on the support member and penetrating the electret electroacoustic transducer;
an electret vibrating film, disposed between the pair of porous complex electrodes, the electret vibrating film having a fixed portion fixed on the support member;
a first adjustment member, disposed in a space between one of the porous complex electrodes and the electret vibrating film, wherein the electret vibrating film has an adjusted portion contiguous with the first adjustment member, and a sectional difference is formed between the fixed portion and the adjusted portion; and
a film, disposed in one side of the porous complex electrode opposite to the electret vibrating film.

13. The transducer of claim 12, further comprising a second adjustment member, wherein the second adjustment member is disposed in a space between another porous complex electrode and the electret vibrating film.

14. The transducer of claim 13, wherein each porous complex electrode further comprises an inner electrostatic protection layer and an outer electrostatic protection layer, the inner electrostatic protection layer is closer to the electret vibrating film than the outer electrostatic protection layer, the inner electrostatic protection layer comprises PVA material.

15. The transducer of claim 14, wherein the adjustment members are adhesive material or viscose, the film is a PVA film, an antistatic PE film or a film having a conductive layer, the outer electrostatic protection layer is a conductor or antistatic material.

16. The transducer of claim 15, wherein each porous complex electrode further comprises a conductive layer and a non-metal material layer, the non-material layer is disposed between the conductive layer and the outer electrostatic protection layer, the conductive layer is contiguous with the inner electrostatic protection layer.

17. The transducer of claim 13, wherein the electret vibrating film is a separable double layers structure, and the adjust portions of the electret vibrating films are disposed near to one of the porous complex electrode or the adjust portions of the electret vibrating films are near to two porous complex electrodes.

18. The transducer of claim 17, wherein each porous complex electrode further comprises an inner electrostatic protection layer and an outer electrostatic protection layer, the inner electrostatic protection layer is closer to the electret vibrating film than the outer electrostatic protection layer, the inner electrostatic protection layer comprises PVA material.

19. The transducer of claim 18, wherein the adjustment members are adhesive material or viscose, the film is a PVA film, an antistatic PE film or a film having a conductive layer, the outer electrostatic protection layer is a conductor or antistatic material.

20. The transducer of claim 19, wherein each porous complex electrode further comprises a conductive layer and a non-metal material layer, the non-material layer is disposed between the conductive layer and the outer electrostatic protection layer, the conductive layer is contiguous with the inner electrostatic protection layer.
